(19) United States
(12) Patent Application Publication
(10) Pub. No.: US 2023/0276830 A1
(43) Pub. Date: Sep. 7, 2023

(54) KOMBUCHA BEVERAGE MANUFACTURED WITH MITRAGYNA SPECIOSA (KRATOM) AND METHODS THEREOF

(71) Applicant: Filipp Mirzakhanov, Centennial, CO (US)

(72) Inventor: Filipp Mirzakhanov, Centennial, CO (US)

(21) Appl. No.: 18/185,574

(22) Filed: Mar. 17, 2023

(51) Int. Cl. A23L 2/38; A23L 2/60; A23L 3/36; A23L 33/135; A23L 33/15

(52) U.S. Cl. CPC A23L 2/382; A23L 2/60; A23L 3/36; A23L 33/135; A23L 33/15

(57) ABSTRACT

An unpasteurized bottled kombucha beverage including kratom, and method thereof. The method includes providing kratom in a sweetened aqueous solution. The kratom includes major kratom alkaloids including mitragynine (MTG), speciogynine (SPG), speciocilliatine (SPC), corynantheidine (COR), 7-hydroxymitragynine (7HMG) and paynantheine (PAY) to define a first alkaloid mix. Next a scoby is added to the aqueous solution to ferment the aqueous solution including the kratom. The step of fermentation yields a second alkaloid mix that do not significantly vary from the first alkaloid mix on a percentage basis e.g. within 10%. The scoby thus produces suspended probiotics and naturally yields a complex of B vitamins during fermentation. The second alkaloid mix, B vitamins and probiotics cooperate to sooth stress in a consumer, particularly stress caused by addictions.

### FIELD OF THE INVENTION

This invention relates to bottled nutraceutical beverages that sooth stress, more particularly the present invention includes a combination of probiotics, B-vitamins, and kratom alkaloids to sooth stress.

### BACKGROUND OF THE INVENTION

Mitragyna speciosa (M. speciosa) is a tropical evergreen tree in the Family Rubiaceae. The Family Rubiaceae also includes coffea, whose cherries are roasted and brewed to make coffee.

M. speciosa grows naturally in southeast Asia, from Thailand to Papua New Guinea. More commonly, this plant is referred to in the west as Kratom. Its' leaves have historically been used for chewing, smoking and tea.

Kratom includes many compounds including Mitragynine, 7-hydroxymitragynine, numerous alkaloids, Raubasine, and more than 40 other compounds. Together these compounds generate an “entourage effect” that many claim helps them overcome opioid addiction.

Many are currently researching the issue of opioid addiction and the beneficial effects that kratom and its constituents may have. Others have experimented with relieving cocaine addiction with kratom use. Subjective information, experience, and well as documented research indicates that kratom can be a part of a holistic solution to opioid addiction as well as cocaine addiction.

The U.S. Food and Drug Administration, however, makes statements indicating lack of awareness of such benefits. The author and inventor of this patent application are fact driven in achieving the goals of the present invention are undeterred by scantily researched statements made by the FDA.

In the field of bottle beverages, many are pasteurized at temperatures and times determined to minimize microbial contamination. Typically pasteurization uses a temperature of less than 212° F. for an appropriate period of time to kill or deactivate microorganisms and enzymes that contribute to spoilage.

One drawback of pasteurization is that nutrients produced by beneficially active microbes and not optimized. Another drawback is that certain vitamins and nutrients are degraded by heating. Accordingly many cold pasteurization processes have been developed to optimize nutrition in beverages, particularly those with botanical components.

One method of avoiding unnecessary heat in a bottling process is called “cold pasteurization”. This uses pressure for between 3-5 minutes to eliminate live microbial pathogens. This has some beneficial effect for preserving vitamins and flavor components.

One drawback of cold pasteurization relates is that beneficial bacteria and other microbes are eliminated along with the pathogenic and undesirable microbes.

Another drawback is that cold pasteurization is often accomplished by applying pressure to prepackaged beverages, which are packaged in a flexible plastic container, having a flexible resin liner. Many like to avoid plastic packaging and packaging with resin liners to reduce consumption of bisphenol A (BPA) which is found in plastics and is a known hormone disruptor, and toxin.

In some instances filters are used to filter microbes without the need for heat to kill or deactivate the microbes. An appropriate filtration scheme can reduce microbes by more than 99%. One drawback of filtration is that certain beneficial microbes are filtered along with the undesirable ones. Many wish to have pro-biotic content in their beverages.

What is desired is a way to process and package nutrient-rich beverages without destroying or deactivating beneficial nutrients, bioactive compounds, vitamins and enzymes.

### Kratom History

For known history Kratom has been used by laborers in south eastern parts of Asia as a mild stimulant. Kratom has antinociceptive properties that may increase endurance and ease pain while laboring. Thus, a benefit of Kratom consumption may include pain management.

As the benefits of Kratom and understood and the herb is more widely distributed, many have found a soothing effects. Recreational usage of Kratom has increased.

Kratom has numerous known bioactive components, and many that are not fully understood. Accordingly, many recognize an “entourage effect” associated with consuming Kratom in its natural form, such as in tea.

The entourage effect of Kratom in its natural form may arise at least partially from the fact that metabolism of the bioactive constituent, Mitragynine, requires Cytochrome P-450 enzymes (P450 enzymes) to effectuate metabolism.

However, the metabolism of Mitragynine yields metabolites that have an inhibitory effects on multiple P450 enzymes. Thus metabolism of Mitragynine may help in preserving numerous kratom components and may be one factor in this entourage effect.

In addition to the metabolites that may inhibit P450 enzymes, the plant may also include additional P-450 enzyme inhibitors. Such inhibitors can increase latency and efficacy of the Mitragynine in vivo. In any event, these enzyme inhibitors likely slow hepatic metabolism of many other compounds when Kratom is consumed orally.

Generally, cytochrome P-450 enzymes contain heme as a cofactor that binds oxygen molecules and thus functions as monooxygenases. In vitro cytochrome P450 inhibition of major kratom alkaloids: mitragynine (MTG), speciogynine (SPG), speciocilliatine (SPC), corynantheidine (COR), 7-hydroxymitragynine (7HMG) and paynantheine (PAY) was evaluated using human liver microsomes (HLMs) to understand their drug-drug interaction potential.

Studies of the plant reveal that in addition to the entourage effects, the isolated component Mitragynine, which is the most abundant indole-based alkaloid in the leaves of the plant, may be the primary component yielding a mild sedative effect and relief from opioid cravings.

It is reported that select Thai varieties have dry leaf concentrations of Mitragynine and 7-hydroxymitragynine that have measured 4.71 to 8.72% and 0.01 to 0.04%, respectively. These are anolymous numbers as most kratom varieties have much less concentrated Mitragynine and 7-hydroxymitragynine.

The Mitragynine concentration is some varieties may rise up to 1% of the dried leaf on a weight to weight basis. A recent study examining the alkaloidal content of 6 commercially available dried and powdered, non-concentrated kratom products found mitragynine and 7-hydroxymitragynine concentrations in the range of 4.71 to 8.72% and 0.01 to 0.04%, respectively. In addition, mitragynine concentrations in bulk leaf samples have been reported in previous studies, varying from 0.80 to 2.38%. Other studies detected corynantheidine, corynoxine, and isocorynantheidine concentrations in commercial kratom products ranging from 0.08 to 0.12%, 0.03 to 0.43%, and 0.05 to 0.13%, respectively. In sum the alkaloid concentrations in Kratom plant matter varies significantly.

Ranges of paynantheine, speciociliatine, and speciogynine were relatively high with concentrations ranging from 1.81 to 3.43%, 1.36 to 4.10%, and 0.87 to 1.42%, respectively. The range of alkaloidal content found in freshly harvested, dried and powdered kratom leaves, however, is largely undocumented in literature. The present invention includes both known and unknown ranges of alkaloidal content, as well as added alkaloidial isolates to achieve a bioactive bottled product, as well as to maintain consistent flavor, and consistent concentrations of alkaloids in any final bottled product.

What is desired is a broadly acceptable way of manufacturing, packaging and delivering Kratom to a consumer. What is also desired is a way of having improved entourage effects on a consumer of Kratom products. What is also desired is a way of bottling kratom beverages that does not degrade efficacy. What is also desired is a way of bottling kratom beverages that uses herbal and nutritional additives to enhance efficacy. What is further desired is a way of improving brewing of a Kratom beverage to yield the maximum concentration of bioactive alkaloids.

### SUMMARY OF THE INVENTION

A bottled kombucha beverage includes live probiotic cultures in a sweetened aqueous solution, and kratom-derived alkaloids selected from the group consisting of mitragynine (MTG), speciogynine (SPG), speciocilliatine (SPC), corynantheidine (COR), 7-hydroxymitragynine (7HMG) and paynantheine (PAY). This invention includes a bottled nutraceutical beverages that sooth stress, and includes naturally occurring (without additives) combination of probiotics, B-vitamins, and kratom alkaloids to sooth stress.

Importantly, heat pasteurization and chemical preservatives are not necessary, and are avoided. Heat pasteurization is known to degrade or denature vitamins such as B vitamins that are naturally produced in live kombucha. Thus the present invention, preferably, does not use heat pasteurization.

While kratom-derived alkaloids are used herein, it can be appreciated that isolated or synthetic alkaloids may be used in alternative embodiments of the invention. Also, while a beverage without additives is described herein, various supplemental vitamins can also be added to achieve ideal nutrient concentrations.

It is preferred to use a whole plant leaf alkaloid mix for numerous reasons including enabling the “entourage effect” in vivo to ease stress, including stress induced by an addiction such as an opioid addiction, cocaine addiction, alcohol addiction and event a tobacco addiction. Also, it has been discovered that as a fermentation substrate that kratom makes a good substrate, and like tea, enables the flavors, smells, and biologically active alkaloids to be preserved better than other processing methods.

The concentrations of kratom beverages can vary. For example a micro-dose concentration of 0.1 grams of kombucha leaf per 12 oz of liquid is used in one example of a bottled kombucha beverage. In another example 10 grams of kratom leaf can be used to make 12 oz of bottled kombucha product. These ratios can vary according to the alkaloid concentrations of the leaf material, and can be scaled for large batch production. It can be appreciated that other parts of the Kratom plant may be used, including roots, stems, and other biomass containing bioactive alkaloids.

The live probiotic cultures includes enteric bacteria including bacteroides thetaiotamicron, Escherichia coli, Enterococcus faecalis, Bacteroides fragilis, Enterobacter cloacae complex, and Akkermansia muciniphila.

The bottled kombucha beverage further includes live acetic acid bacteria and lactic acid bacteria (Lactobacillus). The acetic acid bacteria is selected from the group consisting essentially of Gluconacetobacter and Acetobacter.

In one embodiment of the invention, the live probiotic cultures include yeast of both the Zygosaccharomyces and Brettanomyces genera. In an example of the invention, the sweetened aqueous solution is sweetened with agave nectar and the alkaloids of the sweetened aqueous solution are derived from kratom.

In a preferred embodiment of the invention, a bottled kombucha beverage includes a live kombucha culture in an aqueous solution and total alkaloids selected from the group consisting of mitragynine (MTG), speciogynine (SPG), speciocilliatine (SPC), corynantheidine (COR), 7-hydroxymitragynine (7HMG) and paynantheine (PAY), and combinations thereof. The mitragynine comprises 4.71 to 8.72% of the total alkaloids and the 7-hydroxymitragynine comprises 0.01 to 0.04% of the total alkaloids.

A method of manufacturing a kratom beverage includes providing a fermentable kratom substrate such as kratom leaves, or kratom powder, in an aqueous solution. The method includes the step of brewing the kratom leaves or kratom powder with mild heat.

The fermentable kratom substrate includes alkaloids selected from the group consisting of mitragynine (MTG), speciogynine (SPG), speciocilliatine (SPC), corynantheidine (COR), 7-hydroxymitragynine (7HMG), paynantheine (PAY) and combinations thereof to define a first alkaloid mix. These are not typically degraded by mild heat, but other synergistic or bioactive components may degrade. The present invention seeks to reduce degradation of bioactive components, flavonoids, and aromatic components by adjusting the manufacturing process, for example by avoiding pasteurization, and by brewing at low temperatures.

In one embodiment, brewing is accomplished at room temperature in sunlight.

In another embodiment, brewing preferably includes a sonication step to reduce added heat needed in the brewing process. In one embodiment, this fermentable kratom substrate in an aqueous solution is subject to sonication to separate bioactive alkaloids and other bioactive components from the fermentable substrate. Sonication is preferably at a frequency at 20 kHz, or more, for 30-60 minutes while spinning at 500 rpm and at a temperature of between 70-110 degrees F. This reduces any need for brewing at high temperatures, I. e. above 170 degrees F., and helps to preserve vitamins, volatile flavonoids, and volatile aromatic components that are usually reduced by other brewing processes. It can be appreciated that the sonic frequency can be optimized to be steady, smoothly varied, stepped, or pulsed in various embodiments of the invention.

Next the method includes adding a scoby to the aqueous solution and fermenting the aqueous solution. The fermented aqueous solution includes total alkaloids selected from the group consisting of mitragynine (MTG), speciogynine (SPG), speciocilliatine (SPC), corynantheidine (COR), 7-hydroxymitragynine (7HMG) and paynantheine (PAY), and the mitragynine comprises 4.71 to 8.72% of the total alkaloids and the 7-hydroxymitragynine comprises and 0.01 to 0.04% of the total alkaloids.

The method further includes removing the scoby and filtering the fermented aqueous solution. Next, in a second fermentation step, concentrated juice and sugar are added to the fermented aqueous solution and allow the aqueous solution to ferment into a second fermented aqueous solution, which is then bottled.

The second fermented aqueous solution includes kratom derived alkaloids (total alkaloids) selected from the group consisting of mitragynine (MTG), speciogynine (SPG), speciocilliatine (SPC), corynantheidine (COR), 7-hydroxymitragynine (7HMG) and paynantheine (PAY). The mitragynine comprises 4.71 to 8.72% of the total alkaloids and the 7-hydroxymitragynine comprises between 0.01 to 0.04% of the total alkaloids.

Accordingly, the present invention includes a bottled kratom kombucha product. This kratom kombucha product can be augmented either prior to fermentation, or after fermentation with other botanical ingredients. Such ingredients may be synergistic or complimentary. The augmented ingredients may include cannabis, poppy and coca leaf, or any botanical substance that improves flavor, bioactivity, color or aroma.

The bottled kratom kombucha beverage is neither pasteurized nor sterilized by external processes in order to preserve the kratom alkaloids, which do not significantly (+/−10%) during manufacturing. This maximizes bio-activity of the kratom alkaloids in vivo. Also, an array of fermentable juices of fruit or herbs that can be used by the present invention include cytochrome p450 enzyme inhibitors that when combined with a kratom beverage can improve bio-activity and latency in vivo.

### DETAILED DESCRIPTION

The fermented kombucha kratom beverage of the present invention preserves probiotic content to balance gut microbiome to inhibit depression, optimize immune function and provide a better feeling of well being to the consumer. There are a myriad of other benefits of such probiotic content in easing, soothing and remedying stress in vivo. Also, the present invention delivers a vitamin B complex that is not degraded by heat pasteurization, but instead is preserved by refrigeration. The probiotics and the vitamin B complex cooperates with the kratom alkaloids to sooth stress, including stress induced by addiction. Thus a three pronged approach to remedying stress is provided by the present invention and the various concentrations of active constituents identified herein.

The present invention includes using a kombucha scoby (scoby) to process botanicals into a flavorful, pro-biotic enhanced and nutrient rich beverage. A kombucha scoby is a symbiotic growth of acetic acid bacteria and osmophilic yeast species, typically in the form of a zoogleal mat, poellicle or biofilm. A scoby can be dried and reconstituted or reactivated. This can be done in an aqueous medium or in a fermentation tank, for example. Kombucha yeast often include local yeast species found in the ambient environment, but predominantly includes members of the Zygosaccharomyces and Brettanomyces genera. Bacteria in kombucha typically include acetic acid bacteria such as Gluconacetobacter, Gluconobacter, and Acetobacter, as well as Lactobacillus, e. g. Lactobacillus nagelii. Komagataeibacter species are also commonly used.

Studies of commercial kombucha products have found that commercially sold kombuchas also contained varying levels of enteric bacteria including Bacteroides thetaiotamicron, Escherichia coli, Enterococcus faecalis, Bacteroides fragilis, Enterobacter cloacae complex, and Akkermansia muciniphila.

The fungal composition of commercially sold kombucha products is characterized by predominance of fermenting yeast including Brettanomyces species and Cyberlindnera jadinii. Kombucha varied widely in chemical content assessed by global untargeted metabolomics, with metabolomic variation being significantly associated with metagenomic profiles.

Variation in tea bases, bacteria/yeast starter cultures, and duration of fermentation may all contribute to the observed large differences in the microbial and chemical profiles of final kombucha products.

Fermentation increases many nutrients in drinks such as kombucha, and the microbial content may improve a desirable probiotic balance in the gut of kombucha drinkers.

The scoby can also be presented in dry form, and added in the form of particles to a bioreactor having regulated temperature, pressure and agitation in some alternate embodiments of the invention. In this way consistent batches of kombucha can be realized.

In micro batches, the scoby is typically suspended in an aqueous solution including water, sugars and a nutritious botanical substrate. The substrate in this invention includes plant biomass such as dried leaves that are ground into millimeter dimensions or smaller. The leaves are preferably black tea and kratom in accord with the present invention. Agave nectar makes a good sugar source, as does can sugar, or honey, or combinations thereof. Green tea can also be used as a botanical fermentation substrate.

Additional botanical substrate additives, nutrients, and botanical extracts can be used for flavor and for improving the bioactivity of certain components of the kratom. The additives can include Cytochrome P450 enzyme inhibitors that can be added with the tea and kratom, or added in a post process prior to bottling. Such enzyme inhibitors can be added in bio-active amounts and may simultaneously serve as preservatives for a bottled beverage. Caffeine can also be added.

In other embodiments, the enzyme inhibitors naturally occur in kratom, and also in various other herbs that may be added as a botanical substrate prior to, or after fermentation. Fermentation slows greatly, so we can say that it virtually pauses after bottling.

CYP1A1 Enzyme Inhibiting Herbs

The additives can include CYP1A1 inhibiting herbs such as ground cumin, German chamomile flowers dried and ground, dandelion greens or roots, kava, peppermint leaves ground and dried, and turmeric root. These cytochrome P450 enzyme inhibitors can be added with the tea and kratom, or in a post process added to a beverage prior to bottling. Such enzyme inhibitors can be added in bio-active amounts and may simultaneously serve as preservatives for a bottled beverage.

CYP2B6 Enzyme Inhibiting Herb

Ashwaganda is a useful adaptogen for human consumption that balances hormones, and other regulatory systems in vivo. It also has CYP2B6 Enzyme Inhibiting capabilities that can enhance the bioactivity of kratom. Ashwaganda can be added with the tea and kratom, or in a post process added to a beverage prior to bottling. Such enzyme inhibiting herbage can be added in bio-active amounts and may simultaneously serve as preservatives for a bottled beverage.

CYP2C9 Enzyme Inhibiting Herbs

In another embodiment of the invention, the leaves of Ginkgo biloba and St. Johns Wort are used to inhibit CYP2C9 enzymes. These can be added with the tea and kratom, or in a post process added to a beverage prior to bottling. Such enzyme inhibiting herbs can be added in bio-active amounts and may simultaneously serve as preservatives for a bottled beverage.

Additionally, there are enzyme inhibiting flavonoid components that are known to inhibit cytochrome P450 Enzymes including CYP2C9 and these include Amentoflavone, and Quercetin.

CYP2C19 Enzyme Inhibiting Herbs

Kava is known to inhibit CYP2C19 and other cytochrome P450 enzymes and is likely to enhance the efficacy of kratom when bottled and consumed orally in accordance with the present invention.

CYP2D6 Enzyme Inhibiting Herbs and Niacin

Various herbs including both Kava and St. Johns Wort are known to inhibit CYP2D6 Enzymes. Niacin, niacinamide (collectively vitamin B3) is also a useful additive to enhance efficacy of kratom.

CYP3A4 Enzyme Inhibiting Herbs

Kava, Milk Thistle, Quercetin, Star Fruit, Cafestol, Bergamottin (derived from Grapefruit Pulp) are all effective CYP3A4 enzyme inhibitors that can be additives used to enhance the efficacy of the present invention. Other citrus extracts and essential oils may be effective cytochrome P450 enzyme inhibitors used as both flavor enhancers, enzyme inhibitors, and preservatives for the present invention.

In any case, the beverage is fermented with the kratom, bottled and kept refrigerated to inhibit further fermentation until consumed by a customer. While fermentation may interfere with certain components of the kratom that are desirable, the additives used inhibit further degradation of kratom alkaloids during fermentation, during bottling and storage, and importantly after being consumed. The added components used in accord with the present invention are botanically derived, impart flavor, color and nutritional value desired by many consumers. All added components are synergistically bioactive I.e. enhance the bioactivity of the kratom alkaloids, and may exhibit independent bioactivity. Many also impart flavor or color to a beverage of the present invention.

A bioactive amount of dried and ground kratom is added to each 12 oz portion of the aqueous solution that is later bottled. Ideally 1 gram of kratom is used for a 12 oz portion. In various embodiments 0.1-5 grams of dried kratom can be used. Mitragynine comprises 4.71 to 8.72% of the dried kratom. 7-hydroxymitragynine comprises 0.01 to 0.04% of the dried kratom.

While dried kratom is used as a fermentation substrate, many leaves, flowers, bark, roots, stems, fruits etc. Can be added as a fermentation substrate, for flavor, and for synergistic bio-compatibility. In one embodiment, a cytochrome p450 inhibitor such as lemon, lime, grapefruit or other citrus juice, essential oil, or fruit can be added to improve bio-efficacy in vivo. In other embodiments, the fermentation process is extended longer than 6 days, and up to 12 days, to yield gluconic acid in a concentration of between 1-2.33 g/L. This gluconic acid may inhibit enzymatic activity which could degrade mitragynine.

While a single fermentation step is described, a secondary fermentation step can be used after adding a second or supplemental fermentation substrate. Such a substrate includes pomegranate juice, for example, and may also include citrus, blueberry or other fruit juice. This second fermentation perfects the flavor and optimizes the concentration of desired enzyme inhibitors.

In one embodiment, citric acid, acetic acid, or ascorbic acid are added to limit enzymatic activity and to preserve mitragynine in the product and in vivo.

An example of a method of making the invention includes two primary fermentation steps.

The first fermentation step includes providing a aqueous solution that is a brew of kratom substrate material. The first fermentation step includes a sonication step to make brewing more efficient.

The first fermentation step includes adding a live kombucha scoby after sonication to introduce active bacterial and fungal components. In this embodiment, brewing preferably includes the sonication step to reduce added heat needed in the brewing process. Specifically, the aqueous solution and is subject to sonication to separate bioactive alkaloids and other bioactive components from the fermentable substrate. This accelerates the fermentation step to save time and improve yield of bioactive alkaloids in the fermented aqueous solution.

Sonication is preferably at a frequency at 20 kHz, or more, for 30-60 minutes while spinning at 500 rpm and at a temperature of between 70-110 degrees F. This reduces any need for brewing at high temperatures, I. e. above 170 degrees F., and helps to preserve vitamins, volatile flavonoids, and volatile aromatic components that are usually reduced by other brewing processes. It can be appreciated that the sonic frequency can be optimized to be steady, smoothly varied, stepped, or pulsed in various embodiments of the invention.

The added scoby ferments the brewed kratom solution into the fermented aqueous solution. The second fermentation step adds additional sugars, fruit or fruit juice, other flavors, and other bioactive molecules to improve bioactivity of the kratom alkaloids in vivo. In one embodiment, pomegranate juice concentrate and natural sugars are added for the second fermentation step. A particular example of a manufacturing process in accord with the present invention follows:

### Example 1

Brew kratom powder and water with agitation. In this example 50 g of kratom powder is mixed in (1.5 L) of water, subject to sonication, and stirred with a magnetic stirrer for 30-60 minutes and at 300-500 rpm to optimize solubility and to reduce undesired active microbes.

Next, the brewed kratom solution is filtered, sweetener such as agave nectar is added. For example 150-250 g of sugars per gallon. Add a mature kombucha scoby and enclose with a breathable membrane in a container.

In one embodiment the breathable membrane includes a plurality of layers of cheesecloth. The container is then left for a first. fermentation period at ambient temperature (L e. 80-85 degrees F.) for 7 days.

In the second fermentation step, after the first fermentation period e. g. 7 days, the scoby is removed, and an amount of concentrated juice such as pomegranate juice concentrate is added and mixed into the filtered and fermented kratom solution in a volume of 5-30% of the total solution. More preferably, an amount of concentrated juice is added in an amount of 10-15% of the total solution. The resulting beverage is sealed to enable carbonation for about 3 days at ambient temperature. Next the beverage is filtered and bottled, and refrigerated. This creates a bottled kratom kombucha beverage for soothing stress, including stress induced by opioid, cocaine, alcohol and tobacco addiction.

The cooperation of both fermentation steps produces a complex of B vitamins such as vitamin B9 (folate), vitamin B1 (thiamine), B2 (riboflavin), B3 (niacin), and B6 (pyridoxine) to synergistically enable the soothing of stress of a consumer in vivo. Such stress may include stress caused by opioid, cocaine, alcohol and tobacco addiction. These vitamins, and others, synergistically sooth stress caused by addiction, and can reduce any vitamin deficiency. Preferably sonication is optimized to maintain the integrity of the complex of B vitamins.

Importantly, the fermented kombucha kratom beverage of the present invention preserves probiotic content to balance gut microbiome to inhibit depression, optimize immune function and provide a better feeling of well being to the consumer. Also, the present invention delivers a vitamin B complex that is not degraded by heat pasteurization, but instead is preserved by refrigeration. The probiotics and the vitamin B complex cooperates with the kratom alkaloids to sooth stress, including stress induced by addiction.

Analysis of the alkaloids of the brewed kratom solution is as follows in Table 1.

TABLE 1
Brewed Kratom Solution

| Alkaloid | Concentration mg/fl. Oz. |
|---|---|
| 7-Hydroxymitragynine | <0.100 |
| Isorhynchophylline | <0.100 |
| Mitragynine | 2.01 |
| Mitraphylline | <0.100 |
| Paynantheine | 0.334 |
| Speciociliatine | 0.222 |
| Total Alkaloids | 3.01 |

One embodiment of the present invention utilizing the Brewed Kratom Solution of Table 1 is further fermented and yields bottled kratom kombucha beverage having the test results as shown in Table 2.

TABLE 2
Kratom Kombucha Beverage

| Alkaloid | Concentration mg/fl. Oz. |
|---|---|
| 7-Hydroxymitragynine | <0.100 |
| Isorhynchophylline | <0.100 |
| Mitragynine | 1.97 |
| Mitraphylline | <0.100 |
| Paynantheine | 0.375 |
| Speciociliatine | 0.208 |
| Total Alkaloids | 3.00 |

Comparing Table 1 and Table 2 results indicates that Fermentation of the Kratom Solution does not significantly degrade the specified alkaloids. Thus, the kratom alkaloids are preserved in the kombucha beverage. Refrigeration further preserves these alkaloids for consumption by a consumer wishing to have a kombucha beverage with live kombucha cultures with probiotic benefits as well as kratom that is not degraded by pasteurization or sterilization during bottling.

The concentration of mitragynine in the fermented kratom kombucha beverage, for example, is between 0.1-10 milligrams per fluid ounce (mg/fl. oz), and more preferably 1-5 mg/fl. oz. of the kratom kombucha beverage. In other embodiments, the concentration is between 10.8-2.2 mg/fl. Oz. The brewed kombucha solution has a Mitragynine concentration in the these same ranges as such concentration does not vary significantly I.e. by more than 10%.

The other alkaloids have corresponding equal ranges. For example the paynantheine is between 0.1-1.0 mg/fl. Oz. of the kratom kombucha beverage and the brewed kratom, and preferably between 0.3 and 0.4 mg./fl. Oz.

For example the speciociliatine is between 0.1-1.0 mg/fl. Oz. of the kratom kombucha beverage and the brewed kratom, and preferably between 0.2 and 0.3 mg./fl. Oz.

While the present invention is disclosed in terms of preferred embodiments, and examples, the true scope of the present invention is defined by the appended claims. The present invention is expressed in terms of naturally occurring alkaloids present in the kratom plant material. The concentrations are as tested and there are not any added isolated or synthetic alkaloids. Thus, the present invention is natural, additive free kombucha that is naturally preserved through fermentation without destroying or significantly reducing the bioactive alkaloid concentrations.

While the preferred sweetener includes agave-derived sugars. Alternative sugar sources can be used including cane sugar, maple syrup, date syrup and honey. Of these raw honey is preferred for its health and nutraceutical benefits and it is not degraded significantly by the low heat kombucha brewing process. 2.

I claim:

1. A bottled kombucha beverage, comprising:
a) live probiotic cultures in a sweetened aqueous solution, the aqueous solution including B-vitamins produced by the probiotic cultures;
b) kratom-derived alkaloids selected from the group consisting of mitragynine (MTG), speciogynine (SPG), speciocilliatine (SPC), corynantheidine (COR), 7-hydroxymitragynine (7HMG) and paynantheine (PAY);
c) the mitragynine has a concentration of 0.1-10 mg/fl oz; and
d) the probiotic cultures, the B-vitamins and the kratom-derived alkaloids cooperate to sooth stress in a beverage consumer.

2. The bottled kombucha as set forth in claim 2, wherein the live probiotic cultures includes enteric bacteria including bacteroides thetaiotamicron, Escherichia coli, Enterococcus faecalis, Bacteroides fragilis, Enterobacter cloacae complex, and Akkermansia muciniphila.

3. The bottled kombucha as set forth in claim 3, wherein the live probiotic cultures further include acetic acid bacteria and lactic acid bacteria (Lactobacillus).

4. The bottled kombucha as set forth in claim 2, wherein the acetic acid bacteria is selected from the group consisting essentially of Gluconacetobacter and Acetobacter.

5. The bottled kombucha as set forth in claim 4, wherein the live probiotic cultures include yeast of both the Zygosaccharomyces and Brettanomyces genera.

6. The bottled kombucha as set forth in claim 4, wherein the aqueous solution includes a sweetener selected from the group consisting of agave, maple syrup, honey, cane sugar, date sugar, and combinations thereof.

7. The bottled kombucha as set forth in claim 4, wherein the the mitragynine has a concentration of 1-5 mg/fl oz.

8. A bottled beverage comprising:
a) a live kombucha culture in an aqueous solution;
b) alkaloids selected from the group consisting of mitragynine (MTG), speciogynine (SPG), speciocilliatine (SPC), corynantheidine (COR), 7-hydroxymitragynine (7HMG) and paynantheine (PAY), and
c) the mitragynine has a concentration of 1 to 3 mg/fl. oz of the bottled beverage.

9. The bottled kombucha as set forth in claim 8, wherein the live probiotic cultures comprise enteric bacteria including bacteroides thetaiotamicron, Escherichia coli, Enterococcus faecalis, Bacteroides fragilis, Enterobacter cloacae complex, and Akkermansia muciniphila.

10. The bottled kombucha as set forth in claim 9, wherein the live probiotic cultures further include acetic acid bacteria and lactic acid bacteria (Lactobacillus).

11. The bottled kombucha as set forth in claim 10, wherein the acetic acid bacteria is selected from the group consisting essentially of Gluconacetobacter and Acetobacter.

12. The bottled kombucha as set forth in claim 11, wherein the live probiotic cultures include yeast of both the Zygosaccharomyces and Brettanomyces genera.

13. A method of manufacturing a kratom beverage comprising:
a) providing an aqueous solution including a fermentable kratom substrate including alkaloids selected from the group consisting of mitragynine (MTG), speciogynine (SPG), speciocilliatine (SPC), corynantheidine (COR), 7-hydroxymitragynine (7HMG), paynantheine (PAY) and combinations thereof to define a first alkaloid mix;
b) subjecting the aqueous solution to sonication;
c) adding a scoby to the aqueous solution and fermenting the aqueous solution, the scoby including microbes that produce B vitamins during fermentation to enhance hepatic function in vivo;
d) the fermented aqueous solution includes alkaloids selected from the group consisting of mitragynine (MTG), speciogynine (SPG), speciocilliatine (SPC), corynantheidine (COR), 7-hydroxymitragynine (7HMG), paynantheine (PAY) and combinations thereof to define a second alkaloid mix;
e) removing the scoby and filtering the fermented aqueous solution;
f) the mitragynine has a concentration of 0.1 to 10 mg/fl. oz in both the first alkaloid mix and the second alkaloid mix; and
g) bottling the second alkaloid mix.

14. The method of claim 13 wherein the step of bottling includes bottling using a bottle sized between 5-12 fl. Oz. without heat pasteurization to preserve scoby microbes and vitamin content, and refrigerating the bottled kratom beverage to inhibit further pasteurization.

15. The method of claim 14 further comprising providing a second fermentation step by adding juice and sugar to the fermented aqueous solution and allowing the aqueous solution to ferment into a second fermented aqueous solution with the sugar and juice.

16. The method of claim 15 further comprising bottling the second fermented aqueous solution.

17. The method of claim 16, wherein the second fermented aqueous solution includes kratom derived alkaloids selected from the group consisting of mitragynine (MTG), speciogynine (SPG), speciocilliatine (SPC), corynantheidine (COR), 7-hydroxymitragynine (7HMG) and paynantheine (PAY).

18. The method of claim 17 wherein the mitragynine comprises between 1.8 to 2.2 mg/fl. oz of the bottled beverage.

19. The method of claim 13, wherein the B vitamins are selected from the group consisting of vitamin B9 (folate), vitamin B1 (thiamine), B2 (riboflavin), B3 (niacin), and B6 (pyridoxine) to synergistically enable the soothing of stress in vivo including stress caused by opioid, cocaine, alcohol and tobacco addiction.

20. A method of manufacturing a kratom kombucha beverage comprising:
a) providing an aqueous solution including kratom, the kratom includes kratom alkaloids selected from the group consisting of mitragynine (MTG), speciogynine (SPG), speciocilliatine (SPC), corynantheidine (COR), 7-hydroxymitragynine (7HMG), paynantheine (PAY) and combinations thereof to define a first alakaloid mix;
b) agitating the aqueous solution to solubilize at least some of the kratom alkaloids, filtering and cooling the aqueous solution with the kratom alkaloids;
c) adding a scoby to the aqueous solution with the kratom alkaloids to ferment the aqueous solution and create a complex of B vitamins and probiotics suspended in the aqueous solution;
d) removing the scoby;
e) and adding sugar and a fruit juice and fermenting the aqueous solution a second time;
f) filtering and bottling the aqueous solution to create a kratom kombucha beverage.

21. The method of claim 20, wherein the B vitamins are selected from the group consisting of vitamin B9 (folate), vitamin B1 (thiamine), B2 (riboflavin), B3 (niacin), and B6 (pyridoxine) to synergistically enable the soothing of stress in vivo including stress caused by opioid, cocaine, alcohol and tobacco addiction.

22. The method of claim 21, wherein the probiotics from the scoby along with the B vitamins and the kratom alkaloids sooth stress in a consumer when consumed.
